(19) United States
(12) Patent Application Publication
(10) Pub. No.: US 2019/0184598 A1
(43) Pub. Date: Jun. 20, 2019

(54) EXTRUDER, OPERATIONAL METHOD THEREOF, AND METHOD OF PRODUCING HONEYCOMB GREEN BODY USING SAID EXTRUDER

(71) Applicant: NGK INSULATORS, LTD., Nagoya-Shi (JP)

(72) Inventors: Yasunori YAMAZAKI, Nagoya-Shi (JP); Atsushi SATO, Nagoya-Shi (JP)

(73) Assignee: NGK INSULATORS, LTD., Nagoya-Shi (JP)

(21) Appl. No.: 16/193,215

(22) Filed: Nov. 16, 2018

(30) Foreign Application Priority Data
Dec. 19, 2017 (JP) 2017-243181

(51) Int. Cl. B28B 3/22; B28B 3/26

(52) U.S. Cl. CPC B28B 3/22; B28B 3/269

(57) ABSTRACT

The present disclosure provides an extruder that includes: at least one screw that extends along an axial direction, the screw including a downstream end positioned downstream in a conveying direction of raw material that is conveyed along the axial direction in accordance with rotation of the screw; a housing that houses the screw; and at least one axial support that axially supports the downstream end of the screw, the axial support including at least one rectifier plate.

### CROSS-REFERENCE TO RELATED APPLICATION

The present application claims a priority of Japanese Patent Application No. 2017-243181, filed on Dec. 19, 2017, the entire content of which is expressly incorporated herein by reference.

### TECHNICAL FIELD

The present disclosure is generally related to an extruder, an operational method thereof, and a method of producing a honeycomb green body using the extruder.

### BACKGROUND

Japanese Patent Application Laid-open No. 2017-149002 discloses a biaxial extruder used in a process for extrusion-molding of honeycomb green body. US Patent Application Publication No. 2014/0271969 discloses a technique to restrain a pair of screws for suppressing deflections of the screws. U.S. Pat. No. 3,680,994(B) relates to an extruder for foodstuff, and discloses that a downstream end of a screw housed in a barrel chamber is axially supported at an upper position over an outlet passage that extends downward from the barrel chamber.

### SUMMARY

In a case where a downstream end of a screw is axially supported as disclosed in U.S. Pat. No. 3,680,994(B), a bent would be required for a flow path of raw material, resulting in more complicated configuration of an extruder.

An extruder according to an aspect of the present disclosure may include: at least one screw that extends along an axial direction, the screw including a downstream end positioned downstream in a conveying direction of raw material that is conveyed along the axial direction in accordance with rotation of the screw; a housing that houses the screw; and at least one axial support that axially supports the downstream end of the screw, the axial support including at least one rectifier plate.

In some embodiments, an upstream end of the screw positioned upstream in the conveying direction of the raw material is coupled to a driving mechanism.

In some embodiments, the extruder may further include at least one axial portion that extends along the axial direction toward the screw or toward the axial support, an end of the axial portion being fitted to a first receiving portion of the axial support or with a second receiving portion of the downstream end of the screw such that the screw is free to rotate.

In some embodiments, the axial portion may be inserted into a bushing and/or a sealing member, and/or the axial portion may be fitted to or held by a bearing.

In some embodiments, the first or second receiving portion may receive a bushing to which the axial portion is inserted or a bearing to which the axial portion is coupled.

In some embodiments, the axial portion may have a diameter that is smaller than a diameter of a shaft of the screw.

In some embodiments, the axial portion may be a portion of at least one coupler that couples the downstream end of the screw and the axial support such that the screw is free to rotate.

In some embodiments, the downstream end of the screw is fitted to the rectifier via a coupler such that the screw is free to rotate.

In some embodiments, the coupler is non-rotatably fitted to the downstream end of the screw.

In some embodiments, the rectifier plate includes a first rectifier plate and/or a second rectifier plate, the first rectifier plate having a through-hole into which an axial portion extending along the axial direction from the screw to the rectifier is inserted, and the second rectifier plate having a first receiving portion that is to receive an end of the axial portion.

In some embodiments, the first and second rectifier plates are stacked.

In some embodiments, the first and second rectifier plates are attached to a flange of the housing.

In some embodiments, the extruder may further include a sealing member that prevents the raw material from flowing into the first receiving portion of the second rectifier plate through the through-hole of the first rectifier plate.

In some embodiments, through-channels of the rectifier plate may be arranged in a circle so as to surround the first receiving portion.

In some embodiments, a sealing member is attached to the rectifier plate so as to surround one or more through-channels of the rectifier plate.

A method of producing a honeycomb body according to an aspect of the present disclosure may be a method of producing a honeycomb body from raw material using an extruder according to one of the above described extruders wherein the extruder further comprises an extrusion die disposed downstream of the axial support in the conveying direction of the raw material.

A method of producing a honeycomb body according to an aspect of the present disclosure may be a method of producing a honeycomb body from raw material using an extruder. The extruder may includes:

at least one screw that extends along an axial direction, the screw including a downstream end positioned downstream in a conveying direction of raw material that is conveyed along the axial direction in accordance with rotation of the screw;

a housing that houses the screw;

at least one rectifier plate that axially supports the downstream end of the screw; and

an extrusion die disposed downstream of the rectifier plate in the conveying direction of the raw material.

The method may includes:

conveying the raw material to the extrusion die based on rotation of the screw of the extruder;

cutting a honeycomb green body being continuously extruded from the extrusion die; and

firing the honeycomb green body obtained by the cutting.

An operational method of an extruder according to an aspect of the present disclosure may includes:

rotating at least one screw that extends in an axial direction and is arranged in a housing of the extruder such that raw material is conveyed along the axial direction;

axially supporting, by at least one rectifier plate arranged in the housing, a downstream end of the screw positioned downstream in the conveying direction of the raw material; and

rectifying, by the at least one rectifier plate, the raw material conveyed downstream in accordance with the rotation of the screw.

According to an aspect of the present disclosure, simplification of configuration of extruder may be facilitated.

### BRIEF DESCRIPTION OF DRAWINGS

Hereinafter, non-limiting embodiments of the present disclosure will be discussed with reference to FIGS. 1 to 11 in which like numerals of reference indicate like parts. A skilled person would be able to combine respective embodiments and/or respective features without requiring excess descriptions, and would appreciate synergistic effects of such combinations. Overlapping descriptions among the embodiments would be basically omitted. Referenced drawings are prepared for the purpose of illustration of invention, and might be simplified for the sake of convenience of illustration.

FIG. 1 is a schematic top view of an extruder according to an aspect of the present disclosure.

FIG. 2 is a schematic side view of an extruder according to an aspect of the present disclosure.

FIG. 3 is a schematic view of a non-limiting arrangement where a downstream end of a screw is axially supported by an axial support. An end of an axial portion extending along an axial direction from a screw side toward a rectifier plate is fitted to a first receiving portion of the rectifier plate.

FIG. 4 is a schematic view of a non-limiting arrangement where a downstream end of a screw is axially supported by an axial support. A bushing is received in a first receiving portion of the rectifier plate, and an end of the axial portion is inserted into the bushing.

FIG. 5 is a schematic view of a non-limiting arrangement where a downstream end of a screw is axially supported by an axial support. An end of an axial portion extending along an axial direction from a rectifier plate side toward a screw is fitted to a second receiving portion of the downstream end of the screw.

FIG. 6 is a schematic view of a non-limiting arrangement where a downstream end of a screw is axially supported by an axial support. A bushing is received in a second receiving portion of the downstream end of the screw, and an end of the axial portion is inserted into the bushing.

FIG. 7 is a schematic perspective view of a non-limiting arrangement where a downstream end of a screw is axially supported by an axial support, cross-section being illustrated by hatching of slant lines for the sake of easier understanding.

FIG. 8 is a schematic perspective view of a non-limiting arrangement where a downstream end of a screw is axially supported by an axial support, cross-section being illustrated by hatching of slant lines for the sake of easier understanding.

FIG. 9 is schematic perspective view of a non-limiting arrangement where a downstream end of a screw is axially supported by an axial support, cross-section being illustrated by hatching of slant lines for the sake of easier understanding.

FIG. 10 is schematic perspective view of a reference example where a downstream end of a screw is not axially supported by an axial support, cross-section being illustrated by hatching of slant lines for the sake of easier understanding.

FIG. 11 is a schematic view showing a honeycomb green body.

### DETAILED DESCRIPTION

In the following descriptions, respective features described for an extruder and a method of extruding would be understood as individual features independent to other features, additionally to as combination with other features. The respective features would be understood as individual features without requiring combination with other features, but could be understood as combination with other features. Describing all combinations of individual features would be redundant for a skilled person, and thus omitted. The individual features would be identified by a language of “In some cases”. The individual features would be understood as a universal feature that is effective not only to an extruder and a method of extruding illustrated in the drawings for example, but also effective to other various extruders and methods of extruding not particularly described in the present specification.

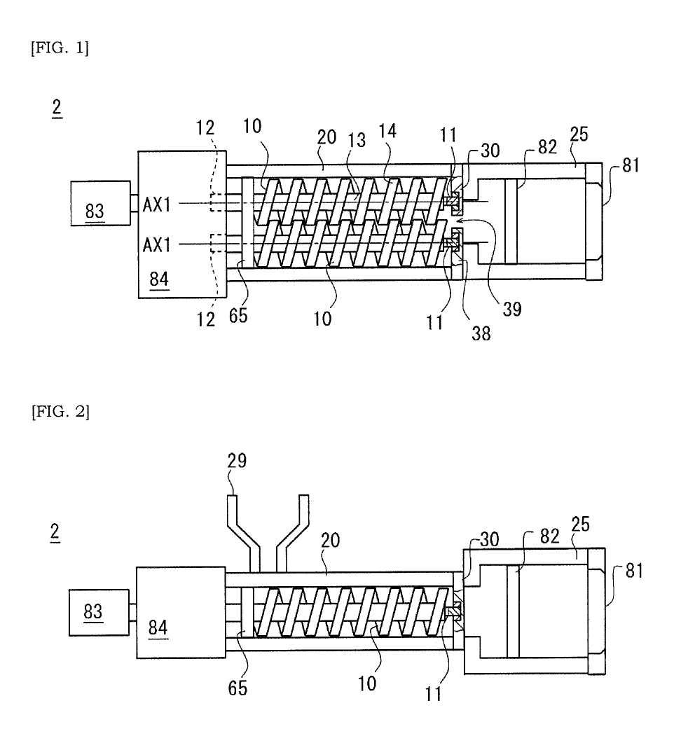

FIG. 1 is a schematic top view of an extruder 2. FIG. 2 is a schematic side view of an extruder 2. As would be understood from FIGS. 1 and 2, in some cases, the extruder 2 has at least one screw 10 extending along an axial direction AX1, and a housing 20 that houses the at least one screw 10. Rotation of the at least one screw 10 causes a raw material to be conveyed along the axial direction AX1. In some cases, the screw 10 is an elongated axial member having a downstream and upstream ends 11, 12 in the conveying direction of the raw material. The screw 10 may be referred to as a screw shaft. The raw material being conveyed along the axial direction AX1 may include the raw material being spirally conveyed along the axial direction AX1.

In some cases, the screw 10 has a shaft 13 extending along the axial direction AX1, and a blade 14 spirally extending along the shaft 13. Embodiment is envisioned where the shaft 13 is omitted. Slight clearance may be provided between the outer periphery of the blade 14 and the inner wall surface of the housing 20. Alternatively, the outer periphery of the blade 14 may touch the inner wall surface of the housing 20, and the outer periphery of the blade 14 may slide on the inner wall surface of the housing 20 in accordance with the rotation of the shaft 13.

Depending on cases, the blade 14 may have different pitches along the axial direction AX1 of the shaft 13, and conveying distance of raw material per one rotation of the screw 10 may not be constant along the axial direction AX1. Notches recessed radially inward of the shaft 13 may be provided at regular or irregular interval in the blade 14. In some cases, the raw material may be clay. In some cases, the raw material includes at least ceramic powder, water, and binder. In some cases, the raw material may be a slurry in which ceramic powder, water, and binder are mixed.

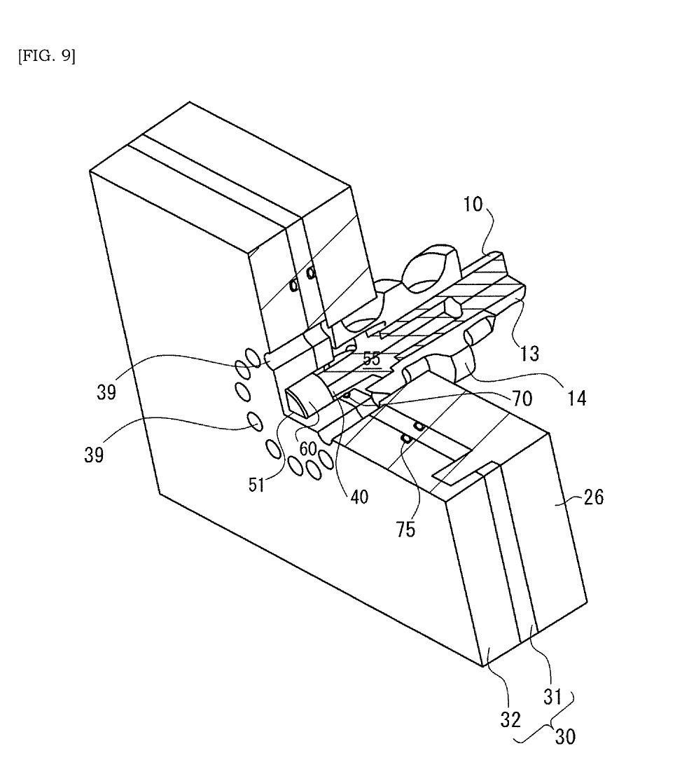

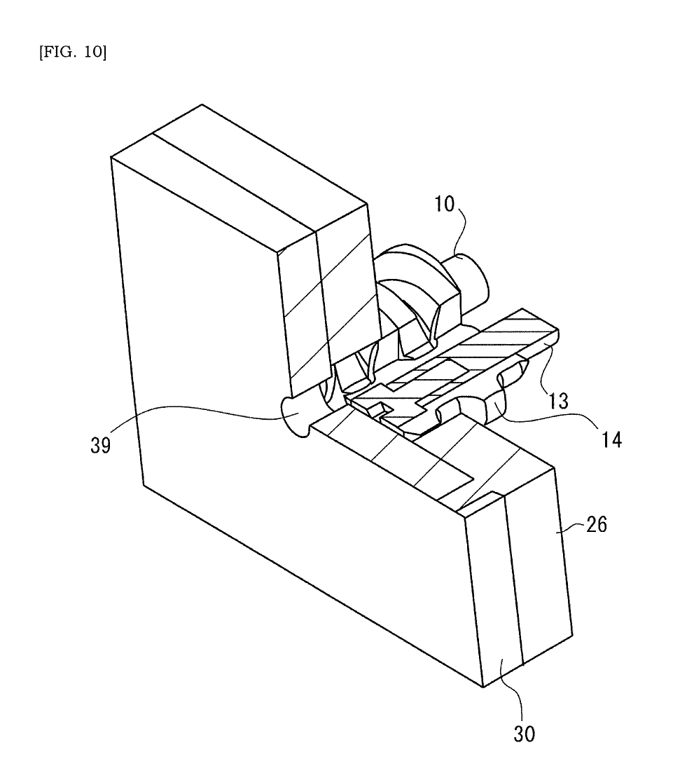

The extruder 2 may have a plurality of, i.e. a pair of screws 10. FIG. 1 shows a case where the extruder 2 has a pair of screws 10. An embodiment is envisioned where the extruder 2 has only one screw 10 (See FIG. 9). An embodiment is also envisioned where the extruder 2 has three or more screws 10. As the number of screws increases, an extrusion-pressure of raw material by the extruder 2 may be increased. The housing 20 may be a tubular member extending along the axial direction AX1 of the screw 10 and/or has an inner wall surface defining a chamber for the screw 10 or a flow passage of raw material, in some cases. The housing 20 can be referred to as a barrel. Both of the screw 10 and the housing 20 may consist of metal. Note that, a hopper 29 for the raw material may be coupled to the housing 20. The hopper 29 may be disposed upstream in the conveying direction of raw material conveyed by the screw 10. It is envisioned that two or more hoppers 29 are coupled to the housing 20.

In the present embodiment, the screw 10 has a downstream end 11 positioned downstream in the conveying direction of the raw material that is conveyed along the axial direction AX1 in accordance with the rotation of the screw 10, and the downstream end 11 of the screw 10 is axially supported by at least one axial support. In other words, additionally to the screw 10 and the housing 20, the extruder 2 is provided with at least one axial support that axially supports the downstream end 11 of the screw 10. Accordingly, an axial deflection or axial swing of the screw 10 would be avoided or suppressed. Note that, in some cases, the upstream end 12 of the screw 10 positioned upstream in the conveying direction of the raw material may be coupled to a driving mechanism, e.g. an output axis of an electric motor 83 or an output axis of a speed reducer 84 described below.

Additionally or alternatively to the feature described in the previous paragraph, in some cases, the screw 10 may be straddle-supported by the driving mechanism and the axial support. In other words, the downstream end 11 and the upstream end 12 of the screw 10 are axially supported by the driving mechanism and the axial support, respectively. Axially supporting the upstream end 12 of the screw 10 may be achieved by coupling the upstream end 12 of the screw 10 to the driving mechanism for driving the screw 10, e.g. an output axis of an electric motor 83 or an output axis of a speed reducer 84 described below. Note that, the downstream and upstream ends 11, 12 may alternatively be referred to as first and second ends.

In some cases, the at least one axial support may include at least one rectifier plate 30. In other words, the rectifier plate 30 functions as the axial support, i.e. the rectifier plate 30 is used as the axial support. Accordingly, mounting to the extruder 2 a dedicated part for the axial support would possible be avoided, and simplification of configuration of the extruder 2 would be facilitated. The rectifier plate 30 is an example of axial support, and thus descriptions about the rectifier plate 30 would equally apply to the axial support. In light of such a viewpoint, in the present specification, the rectifier plate 30 can be replaced with the axial support so that the meanings of sentences would be understood. For example, a sentence “the extruder 2 has one plate-like rectifier plate 30 that is arranged orthogonal to the axial direction AX1” would be understood to indicate “the extruder 2 has one plate-like axial support that is arranged orthogonal to the axial direction AX1” either.

The rectifier plate 30 may be any part that has a functionality of rectifying the flow of raw material. In some cases, the rectifier plate 30 has a flat plate 38 and one or more through-channels 39 that penetrate the flat plate 38. The raw material being conveyed continuously or intermittently by the one or more screws 10 would be prevented by the flat plate 38 from outflowing downstream, but it can indeed flow downstream through the one or more through-channels 39 arranged in the flat plate 38. Number, outline shape, and arrangement manner of the through-channels 39 would be various. Note that, other parts such as, e.g. an extrusion die 81 or a mesh 82 described below could be employed as the axial support.

In some cases where a pair of screws 10 is employed, an extrusion-period of raw material by one screw 10 and an extrusion-period of raw material by the other screw 10 may be complementary. That is, in a time period during which raw material is extruded by the first screw 10, raw material is not extruded by the second screw 10. In a time period during which raw material is extruded by the second screw 10, raw material is not extruded by the first screw 10. The rectifier plate 30 is disposed downstream of the screw 10, and the raw materials alternately conveyed by the pair of screws 10 are transferred into and stored in a pooling space between the screws 10 and the rectifier plate 30. Certain amount of raw materials are newly alternately conveyed by the pair of screws 10 to the pooling space and, accordingly a part of raw material filled in the pooling space is extruded downward through the through-channels 39 of the rectifier plate 30. When the respective paired screws 10 rotate continuously, the raw material would be extruded at a constant rate through the through-channels 39 of the rectifier plate 30.

The extruder 2 may have a driving mechanism to rotate the screws 10. The driving mechanism may be arranged integrally or separately to the housing 20. The driving mechanism may include an electric motor 83 and a speed reducer 84, for example. A rotational torque produced by the electric motor 83 is increased by the speed reducer 84 and transmitted to the screw 10. The electric motor 83 may be a stepping motor, for example. Any kind of speed reducer available in market such as a planetary speed reducer or worm speed reducer can be employed as the speed reducer 84.

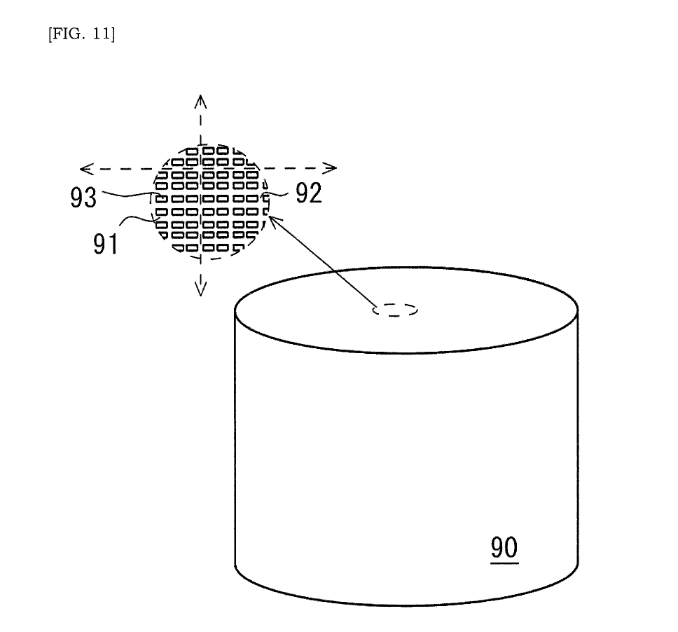

Optionally, the extruder 2 may have an extrusion die 81 and/or a mesh 82. The extrusion die 81 and/or the mesh 82 is disposed downstream of the axial support in the conveying direction of the raw material. The extrusion die 81 may be a molding part for molding the raw material so as to have a honeycombed structure of a honeycomb green body such as illustrated in FIG. 11. By passing through the extrusion die 81, the raw material is molded to form cell-walls of the green honeycombed structure, and the cell-walls define opening cells. Note that, the cells may have various shapes such as rectangular, pentagonal, hexagonal shapes. “Honeycomb or honeycombed structure” includes any lattice shapes that are different from a typical lattice shape of beehive. The mesh 82 is provided to exclude contaminants included in the raw material. In FIGS. 1 and 2, the extruder 2 has a housing 25 that is provided downstream of the housing 20 and is integral to or separated from the housing 20. The extrusion die 81 and mesh 82 are attached to the housing 25.

In some cases, the extruder 2 has an axial support 65 that supports the upstream end 12 side of the screw 10. The axial support 65 may have one or more through-holes into which the shaft 13 of the screw 10 is inserted. A bushing and/or O-ring may be arranged in the through-hole of the axial support 65 into which the shaft 13 is inserted.

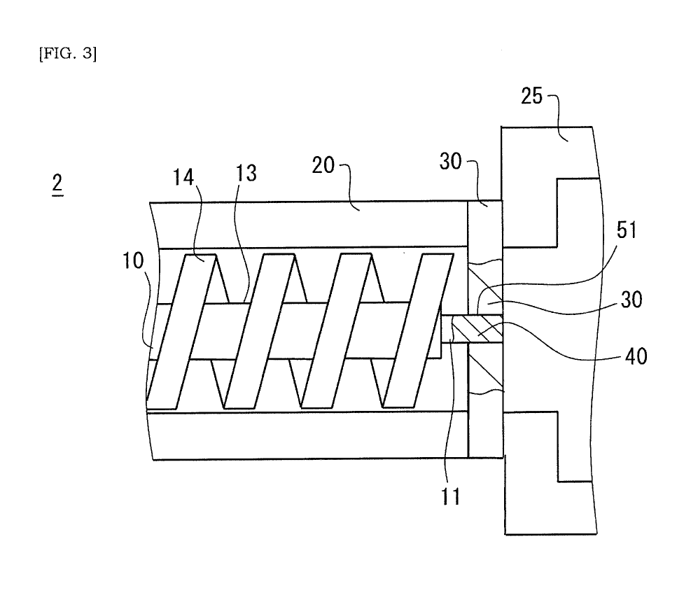

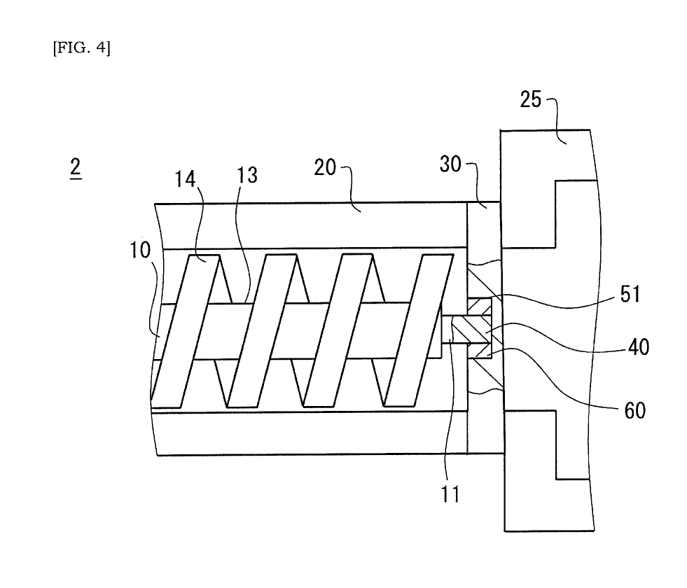

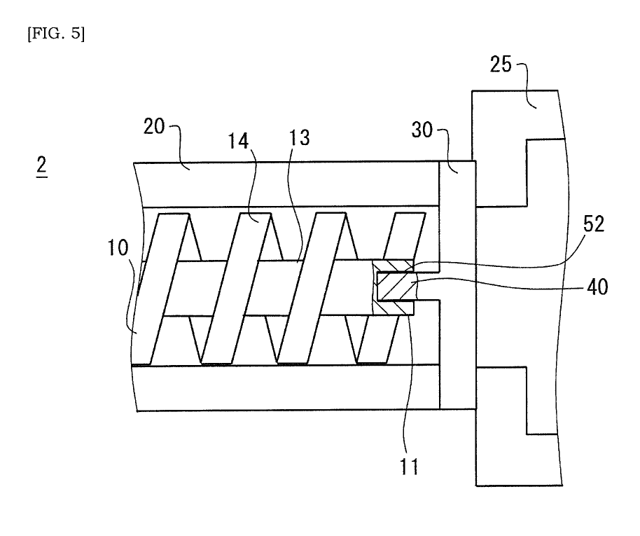

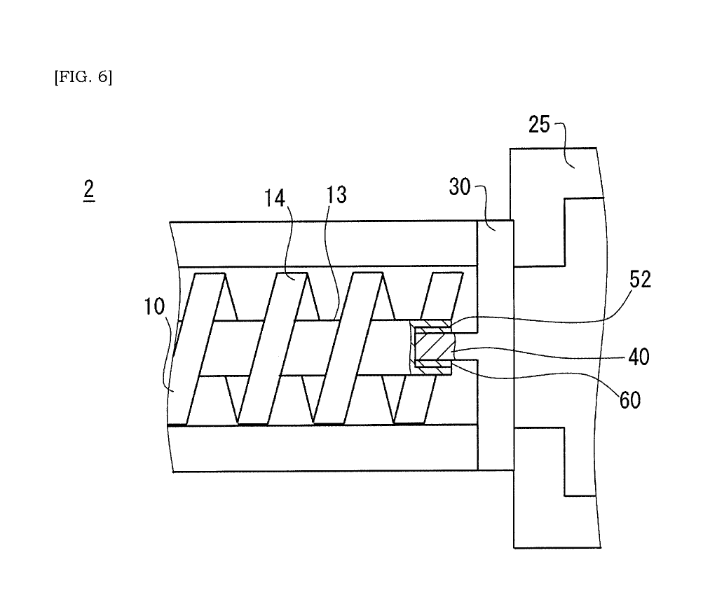

Non-limiting arrangements of the axially supported downstream end 11 of the screw 10 will be described with reference to FIGS. 3-6. Note that, readily envisioned is that the downstream end 11 of the screw 10 is axially supported by the axial support in a manner other than illustrated in the drawings of the present application. In FIG. 3, an end (downstream end) of the axial portion 40 extending along the axial direction AX1 from the screw 10 side toward the rectifier plate 30 is fitted to a first receiving portion 51 of the rectifier plate 30. In FIG. 4, a bushing 60 is received in the first receiving portion 51 of the rectifier plate 30 and the end (downstream end) of the axial portion 40 is inserted into the bushing 60. The bushing 60 may be attached to the end (downstream end) of the axial portion 40. The end (downstream end) of the axial portion 40 to which the bushing 60 is attached may be loosely fitted to the first receiving portion 51. In FIG. 5, an end (upstream end) of the axial portion 40 extending along the axial direction AX1 from the rectifier plate 30 side toward the screw 10 is fitted to a second receiving portion 52 of the downstream end 11 of the screw 10. In FIG. 6, a bushing 60 is received in the second receiving portion 52 of the downstream end 11 of the screw 10 and the end (upstream end) of the axial portion 40 is inserted into the bushing 60.

The receiving portion such as the first or second receiving portion 51, 52 may be an opening with or without a bottom. The first receiving portion 51 in FIG. 3 is a bottomless opening, and penetrates the axial support. The first receiving portion 51 in FIG. 4 is an opening with a bottom, and does not penetrate through the axial support. The second receiving portion 52 in FIGS. 5 and 6 is an opening with a bottom. Depth direction of the first and second receiving portions 51, 52 matches the axial direction AX1 that is equal to the extending direction of the axial portion 40. In some cases, the receiving portion has a circular inner-wall profile in a plane orthogonal to the axial direction AX1 of the screw 10.

In some cases, at least one axial portion 40 extends along the axial direction AX1 toward the screw 10 or toward the axial support, and an end of this axis portion 40 is fitted to a first receiving portion 51 of the axial support or a second receiving portion 52 of the downstream end 11 of the screw 10 such the screw 10 is free to rotate. This fitting may be a loose-fitting, a tight-fitting or any other manners of fittings. In some cases, the axial portion 40 may be a cylinder portion having a circular cross-sectional shape, thus facilitating smooth rotation of the screw 10.

In some cases, one of the screw 10 and the axial support is provided with the axial portion 40, or the axial portion 40 is coupled to one of the screw 10 and the axial support. In some cases of FIGS. 3 and 4, it is the screw 10 that has the above-described axial portion 40. In some cases of FIGS. 5 and 6, it is the axial support (the rectifier plate 30) that has the above-described axial portion 40. As such, manners of axially supporting the downstream end 11 of the screw 10 by the axial support would be various.

Preferably, (i) the axial portion 40 is inserted into a bushing 60 and/or a sealing member 70 and/or (ii) the first or second receiving portion 51, 52 receives a bushing 60 into which at least one axial portion 40 is inserted. The use of the bushing 60 may improve rotational stability of the screw 10. A bearing (e.g. a needle bearing) can be employed as an alternative of the bushing 60. In this case, (i) the axial portion 40 is coupled to the bearing or supported by the bearing and/or (ii) the first or second receiving portion 51, 52 receives a bearing that is coupled to the at least one axial portion 40. Various types of bearing could be used and should not be limited to a particular bearing. As an embodiment where the axial portion 40 is coupled to the bearing, an outer ring of a needle bearing may be fixed to the rectifier plate 30, and an inner ring of the needle bearing may be fixed to the axial portion 40. As an embodiment where the axial portion 40 is supported by a bearing, an embodiment is envisioned where needle rotators of a needle bearing touch an outer periphery of the axial portion 40 of the screw 10. Note that reduced smoothness of rotation of the screw 10 is avoided or suppressed by the employment of the sealing member 70. The sealing member 70 may be an O-ring. Note that, the bushing 60 is a hollow cylinder and facilitates stable or smooth rotation of the axial portion 40. The bushing 60 may be a metal hollow cylinder.

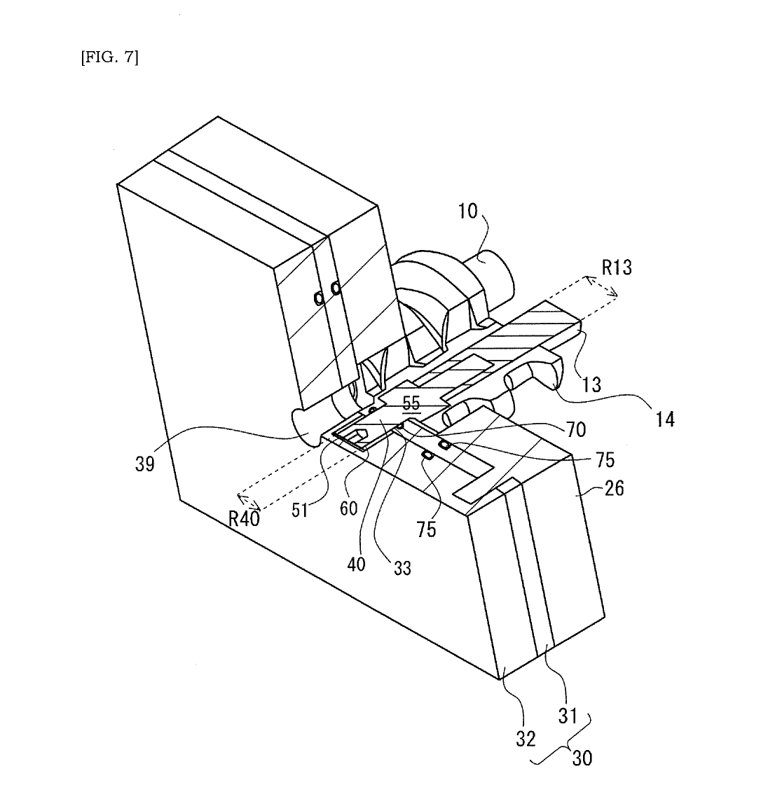

FIGS. 7-9 are schematic perspective views of non-limiting arrangements where the downstream end 11 of the screw 10 is axially supported by the axial support, cross-section being illustrated by hatching of slant lines for the sake of easier understanding. FIG. 10 is schematic perspective view of a reference example where the downstream end 11 of the screw 10 is not axially supported by the axial support, cross-section being illustrated by hatching of slant lines for the sake of easier understanding.

As would be understood from FIGS. 7-9, in some cases, the above-described axial portion 40 is a portion of at least one coupler 55 that couples the downstream end 11 of the screw 10 and the axial support (rectifier plate 30) such that the screw 10 is free to rotate. In some cases, the downstream end 11 of at least one screw 10 and at least one rectifier plate 30 are coupled via the coupler 55 such that at least one screw 10 is free to rotate. More appropriate or easier coupling of the downstream end 11 of the screw 10 and the axial support (rectifier plate 30) may be facilitated by the use of the coupler 55.

In some cases, the coupler 55 is rotatably attached to at least one of the screw 10 and the axial support (rectifier plate 30) and, accordingly, the rotation of the screw 10 is allowed. In some cases, the coupler 55 is non-rotatably mated with the downstream end 11 of at least one screw 10. The coupler 55 and the screw 10 may be firmly coupled by welding or adhesive. The coupler 55 may consist of metal or alloy which is different from and, for example, which is harder or softer than the shaft 13 of the screw 10 and/or the blade 14. In some cases, the axial portion 40 has a diameter R40 that is less than a shaft diameter R13 of the screw 10. The flow of raw material conveyed downward by the rotation of the screw 10 is prevented or suppressed from being impeded by the axial portion 40.

The rectifier plate 30 includes a first rectifier plate 31 having a through-hole 33 into which the axial portion 40 extending along the axial direction AX1 toward the screw 10 or toward the rectifier plate 30 is inserted, and/or a second rectifier plate 32 having a first receiving portion 51 that receives an end (downstream end) of the axial portion 40. The through-channel 39 of the first rectifier plate 31 is in communication with the through-channel 39 of the second rectifier plate 32 and, for example they are co-axially arranged. When a sealing member is arranged in the through-hole 33 and a bushing 60 is arranged in the first receiving portion 51, the raw material is prevented from flowing into the first receiving portion 51 of the second rectifier plate 32 through the through-hole 33 of the first rectifier plate 31. In some cases, the extruder 2 has a sealing member 70 that prevents the raw material from flowing into the first receiving portion 51 of the second rectifier plate 32 through the through-hole 33 of the first rectifier plate 31. O-ring or other sealing members may be used for sealing member 70.

A sealing member 75 may be attached to the rectifier plate 30 so as to surround one or more through-channels 39 of the rectifier plate 30. The sealing member 75 may be an O-ring or a linear sealing member that is laid in a circle. The sealing member 75 may be laid in a circular groove formed in a surface of the rectifier plate 30. The sealing member 75 avoids or suppresses a leakage of raw material.

The above-described first and second rectifier plates 31, 32 are stacked, thus facilitating easier assembling. The first and second rectifier plates 31, 32 are attached to a flange 26 of the housing 20, thus facilitating easier assembling. The flange 26 of the housing 20 is a protruding portion from the inner wall surface of the housing 20 to the screw 10, i.e. radially inwardly of the housing 20. In some cases, the rectifier plate 30 is fixed to the flange 26 of the housing 20 through mechanical fit. In FIGS. 7-9, the flange 26 has a projection projected along the axial direction AX1. This projection of the flange 26 is inserted through the through-hole of the first rectifier plate 31 and fitted to a recess of the second rectifier plate 32. An embodiment is envisioned where a projection is provided on the second rectifier plate 32, and the projection is inserted through the through-hole of the first rectifier plate 31 and fitted to a recess of the flange 26.

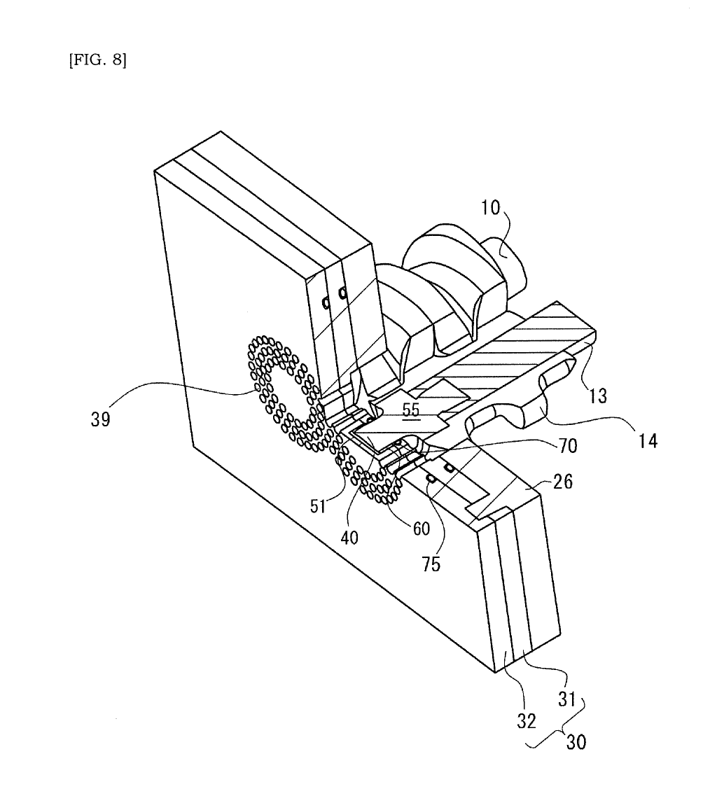

In a case of FIG. 7, the rectifier plate 30 is provided with one through-channel 39, but should not be limited to this. The rectifier plate 30 may be provided with a plurality of through-channels 39 as shown in FIGS. 8 and 9. The through-channels 39 of the rectifier plate 30 are arranged in a circle so as to surround the first receiving portion 51. The number of circular arrangements may be one or more. FIG. 8 shows 3 circular arrangements of through-channels 39. FIG. 9 shows one circular arrangement of through-channels 39.

In the cases of FIGS. 1-8, a pair of screws is provided, but should not be limited to this. One screw 10 may be provided as shown in FIG. 9. In FIG. 9, a portion of hollow-cylindrical bushing 60 arranged in the first receiving portion 51 is illustrated.

As to operation of the extruder 2, a switch of the electric motor 83 is firstly turned ON and the screw 10 starts to rotate. Next, raw material is fed continuously into the housing 20 through the hopper 29. The rotation of the screw 10 conveys the raw material along the axial direction AX1 of the screw 10. The raw material conveyed by the screw 10 flows into and is stored in a pooling space between the screw 10 and the rectifier plate 30. A part of the raw material filled in this space is extruded downward via the through-channels 39 of the rectifier plate 30. A space between the rectifier plate 30 and the mesh 82 would be filled by the raw material extruded downward via the through-channels 39 of the rectifier plate 30. A space between the mesh 82 and the extrusion die 81 would be filled by the raw material which has passed the mesh 82. The raw material is continuously fed into the housing 20 and the screw 10 is continuously rotated. The raw material would be molded to be a honeycombed-like by the extrusion die 81, and a honeycomb molded body, i.e. honeycomb green body would be continuously extruded from the extruder 2. In the next step, the honeycomb green body continuously extruded from the extrusion die 81 would be cut. In the next step, the cut honeycomb green body would be dried and then fired.

Analysis by the present inventors has revealed that a cantilevered screw 10 may possibly suffer an axial deflection or axial swing, depending onto a raw material, e.g. its composition or viscosity, to be fed into the housing 20 of the extruder 2. This axial deflection or axial swing of the screw may accompany a contact between the screw (particularly its downstream end (The downstream end is a free end)) and the housing, thus causing wear of the screw and/or the housing and possibly shortening the lifetime (exchanging cycle) of the screw and/or the housing. Additionally or alternatively, this axial deflection or axial swing of the screw may destabilize extrusion-speed of raw material by the extruder. For example, the extent of axial deflection or axial swing may be increased as the wear of the inner wall of the housing progresses, and an amount of extruded raw material may be destabilized. In the present disclosure, the downstream end 11 of at least one screw 10 is axially supported by at least one axial support, and a technical problem of axial deflection/swing of screw would be avoided or suppressed accordingly.

When the extruder is used to produce a ceramic honeycomb green body, there are cases where thicknesses of cell-walls 91, 92 defining cells 93 in the honeycomb green body 90 are demanded to be thinner (See FIG. 11). In some cases, the thicknesses of the cell-walls 91, 92 are 0.05 to 0.30 mm. If the thicknesses of the cell-walls 91, 92 are reduced in accordance with that demand, there may be cases where it is more difficult to secure the shapes of the cell-walls 91, 92 as intended. For example, during or after the step of firing, pin-holes or cracks may be formed in the cell-walls 91, 92. In light of such an aspect, one may consider to reduce an amount of ingredient to be volatilized during firing e.g. an amount of binder, and to feed to the extruder a raw material with increased viscosity. However, in this case, greater torque would be required for rotating the screw and an extent of axial deflection/swing of the screw would be greater, resulting in one or more above-described unfavorable outcomes. In the present disclosure, the downstream end 11 of at least one screw 10 is axially supported by at least one axial support, allowing the use of raw material prepared for thinner thickness cell-walls.

In an example of FIG. 10, the downstream end 11 of the screw 10 may touch the flange 26 due to the axial deflection/swing of the screw 10. Chipping of the screw 10 or the flange 26 may be caused, and a running cost of the extruder 2 may be increased, resulting in increased cost of honeycomb bodies or making it impossible to use a raw material prepared for thinner thickness cell-walls.

The honeycomb green body illustrated in FIG. 11 is produced by using the extruder 2 which further comprises an extrusion die 81 disposed downstream of the axial support in the conveying direction of the raw material, additionally to the screw 10, the housing 20, and the axial support. In some cases, a method of producing a honeycomb green body includes: conveying a raw material to the extrusion die 81 based on rotation of the screw 10 of the extruder 2; cutting a honeycomb green body being continuously extruded from the extrusion die; and firing the honeycomb green body obtained by the cutting. Each step would be performed based on existing established condition.

Based on the above disclosure, an operational method of extruder that comprises at least one screw 10 extending along the axial direction AX1 and a housing 20 that houses the at least one screw 10 is also apparently disclosed. This method includes a step of rotating the screw 10 to convey the raw material along the axial direction AX1. Here, the screw 10 has a downstream end 11 positioned downstream in the conveying direction of the raw material along the axial direction AX1, and the downstream end 11 of the screw 10 is axially supported by at least one axial support. Improved operational method of extruder 2 is provided.

As an additional option, the method includes rectifying, by at least one rectifier plate 30, the raw material conveyed downstream in accordance with the rotation of the at least one screw 10. Here, the downstream end 11 of the screw 10 is axially supported by at least one rectifier plate 30. Accordingly, mounting a dedicated part of an axial support to the extruder 2 would be avoided, likewise the above descriptions. One or more features stated for the extruder 2 would be understood to be effective to the operational method of the extruder 2 as they are, and thus overlapping descriptions are omitted.

A skilled person in the art would be able to add various modifications to the respective embodiments based on the above teachings.

### REFERENCE NUMBERS

2 Extruder
10 Screw
11 Downstream end
20 Housing
30 Axial support, Rectifier plate

1. An extruder comprising:
at least one screw that extends along an axial direction, the screw including a downstream end positioned downstream in a conveying direction of raw material that is conveyed along the axial direction in accordance with rotation of the screw;
a housing that houses the screw; and
at least one axial support that axially supports the downstream end of the screw, the axial support including at least one rectifier plate.

2. The extruder according to claim 1, wherein the downstream end of the screw is coupled to the rectifier plate via a coupler such that the screw is free to rotate.

3. The extruder according to claim 1, wherein the rectifier plate includes first and second rectifier plates, the first rectifier plate having at least one through-hole into which an axial portion extending along the axial direction from the screw to the rectifier plate is inserted, and the second rectifier plate having a receiving portion that is to receive an end of the axial portion.

4. The extruder according to claim 1, wherein the rectifier plate includes first and second rectifier plates which are stacked, the first rectifier plate having a through-hole into which an axial portion extending along the axial direction from the screw to the rectifier plate is inserted, and the second rectifier plate having a receiving portion that is to receive an end of the axial portion.

5. The extruder according to claim 3, wherein the second rectifier plate is provided with through-channels arranged in a circle so as to surround the receiving portion.

6. The extruder according to claim 3, wherein the through-hole of the first rectifier plate is provided with a sealing member, and the receiving portion of the second rectifier plate is provided with a bushing.

7. The extruder according to claim 3, wherein the first and second rectifier plates are attached to a flange inwardly extending from an inner wall surface of the housing.

8. The extruder according to claim 1, wherein an upstream end of the screw positioned upstream in the conveying direction of the raw material is coupled to a driving mechanism.

9. The extruder according to claim 1, further comprising:
at least one axial portion that extends along the axial direction toward the rectifier plate, an end of the axial portion being fitted to a first receiving portion of the rectifier plate such that the screw is free to rotate.

10. The extruder according to claim 1, further comprising:
at least one axial portion that extends along the axial direction toward the screw, an end of the axial portion being fitted to a second receiving portion of the downstream end of the screw such that the screw is free to rotate.

11. The extruder according to claim 10, wherein the axial portion is inserted into a bushing or a sealing member received in the first receiving portion, and/or the axial portion is fitted to or held by a bearing received in the first receiving portion.

12. The extruder according to claim 11, wherein the axial portion is inserted into a bushing or a sealing member received in the second receiving portion, and/or the axial portion is fitted to or held by a bearing received in the second receiving portion.

13. A method of producing a honeycomb body from raw material using an extruder, the extruder comprising:
at least one screw that extends along an axial direction, the screw including a downstream end positioned downstream in a conveying direction of raw material that is conveyed along the axial direction in accordance with rotation of the screw;
a housing that houses the screw;
at least one rectifier plate that axially supports the downstream end of the screw; and
an extrusion die disposed downstream of the rectifier plate in the conveying direction of the raw material, the method comprising:
conveying the raw material to the extrusion die based on rotation of the screw of the extruder;
cutting a honeycomb green body being continuously extruded from the extrusion die; and
firing the honeycomb green body obtained by the cutting.

14. An operational method of an extruder, the method comprising:
rotating at least one screw that extends in an axial direction and is arranged in a housing of the extruder such that raw material is conveyed along the axial direction;
axially supporting, by at least one rectifier plate arranged in the housing, a downstream end of the screw positioned downstream in the conveying direction of the raw material; and
rectifying, by the at least one rectifier plate, the raw material conveyed downstream in accordance with the rotation of the screw.
